(19) United States
(12) Patent Application Publication
(10) Pub. No.: US 2019/0086689 A1
(43) Pub. Date: Mar. 21, 2019

(54) EYEGLASSES STRUCTURE

(71) Applicant: GOOD BOND OPTOELECTRONIC CO., LTD., New Taipei City (TW)

(72) Inventor: CHUNG-WEI LIN, New Taipei City (TW)

(21) Appl. No.: 16/127,221

(22) Filed: Sep. 10, 2018

(30) Foreign Application Priority Data
Sep. 15, 2017 (TW) 106213738

(51) Int. Cl. G02C 5/22; G02C 1/06

(52) U.S. Cl. CPC G02C 5/22; G02C 2200/08; G02C 1/06

(57) ABSTRACT

An eyeglasses structure is disclosed in accordance with the present invention. A connecting part is disposed between each of two opposite sides of a lens chassis and a corresponding one of two earpiece frames of a pair of eyeglasses having the eyeglasses structure. The connecting part is connected with the each of the two opposite sides of the lens chassis at one end of the connecting part. Hence, the pair of eyeglasses of the present invention has functions to conveniently replace the earpiece frames and adjust positions of the earpiece frames.

### BACKGROUND OF THE INVENTION

### 1. Field of the Invention

The present invention is related to a structure of eyeglasses. Particularly, the present invention is related to a pair of eyeglasses having a design of a connecting part disposed between each of two opposite sides of a lens chassis of the pair of eyeglasses and a corresponding one of two earpiece frames of the pair of eyeglasses. As a result, the pair of eyeglasses has functions to replace the earpiece frames and adjust positions of the earpiece frames, and the structure of eyeglasses is suitable for applying any kinds of structures of eyeglasses.

### 2. The Related Arts

At present, most of glasses on the market are designed to have a frame respectively extending to form a fixing base at each of two opposite sides of the frame. Earpieces are then screwed to the fixing bases, respectively, for assembly with the frame. Hence, the earpieces are able to respectively rotate inwards against the frame for convenient storage of glasses.

However, since the fixing base extending from the frame is usually welded together with the frame, the earpiece correspondingly screwed to the fixing base can only rotate inwards against the frame. It is impossible for the earpiece to move up and down for adjustment. As a result, in use, such design of the earpiece is prone to causing uncomfortable feelings for a glasses wearer when the earpiece is placed on a corresponding ear of the wearer, and is supposed to be closely fit with the corresponding ear of the wearer in order to avoid such uncomfortable feelings. Hence, the glasses wearer frequently takes off the glasses in order to relieve such uncomfortable feelings.

### SUMMARY OF THE INVENTION

A main object of the present invention is to provide an eyeglasses structure. A pair of eyeglasses having the eyeglasses structure comprises a connecting part disposed between each of two opposite sides of a lens chassis of the pair of eyeglasses and a corresponding one of two earpiece frames of the pair of eyeglasses. The connecting part is connected with the each of the two opposite sides of the lens chassis at one end of the connecting part. A pressing resilient piece is disposed in the connecting part. An accommodating space is formed at one end of the corresponding one of the two earpiece frames. An aperture is formed at a lateral side of the one end of the corresponding one of the two earpiece frames. When the other end of the connecting part is assembled in the accommodating space of the one end of the corresponding one of the two earpiece frames, the pressing resilient piece in the connecting part abuts against the aperture of the lateral side of the one end of the corresponding one of the two earpiece frames. As a result, the pair of eyeglasses of the present invention has a function to replace the earpiece frames in order for enhancing whole practicability of the pair of eyeglasses.

Another object of the present invention is to provide an eyeglasses structure. A pair of eyeglasses having the eyeglasses structure comprises a tooth groove having protruding teeth therein being formed in the accommodating space of the one end of the corresponding one of the two earpiece frames. A pointing tip is formed and extends at the other end of the connecting part. When the pointing tip of the other end of the connecting part penetrates through the accommodating space of the one end of the corresponding one of the two earpiece frames, the pointing tip is correspondingly placed at a location in the tooth groove between two of the protruding teeth of the tooth groove. As a result, the corresponding one of the two earpiece frames is able to adjust positions and angles thereof up and down. The pair of eyeglasses is therefore equipped with a function of adjusting earpiece frames thereof, and is able to enhance whole practicability of the pair of eyeglasses.

In order to achieve the above mentioned object(s), a pair of eyeglasses having the eyeglasses structure in accordance with the present invention comprises a lens chassis and two earpiece frames. The two earpiece frames respectively disposed at two opposite sides of the lens chassis. Particularly, a connecting part is disposed between each of the two opposite sides of the lens chassis and a corresponding one of the two earpiece frames. The connecting part is connected with the each of the two opposite sides of the lens chassis at one end of the connecting part. A pressing resilient piece is disposed in the connecting part. An accommodating space is formed at one end of the corresponding one of the two earpiece frames. An aperture is formed at a lateral side of the one end of the corresponding one of the two earpiece frames. When the other end of the connecting part is assembled in the accommodating space of the one end of the corresponding one of the two earpiece frames, the pressing resilient piece in the connecting part abuts against the aperture of the lateral side of the one end of the corresponding one of the two earpiece frames.

### BRIEF DESCRIPTION OF THE DRAWINGS

The present disclosure will become more readily apparent to those ordinarily skilled in the art after reviewing the following detailed description and accompanying drawings, in which:

FIG. 1 is a schematic perspective view of an appearance of a pair of eyeglasses in accordance with the present invention.

FIG. 2 is a schematic exploded perspective view of the pair of eyeglasses of FIG. 1 in accordance with the present invention.

FIG. 3 is a schematic perspective view of an appearance of a connecting part of the pair of eyeglasses of FIG. 1 in accordance with the present invention.

FIG. 4 is a schematic perspective view of the pair of eyeglasses of FIG. 1 with a partially enlarged perspective view showing connection between an earpiece frame and a lens chassis thereof in accordance with the present invention.

FIG. 5 is a schematic partial cross-sectional view of the pair of eyeglasses of FIG. 1 showing connection between the earpiece frame and the lens chassis thereof in accordance with the present invention.

FIG. 6 is a schematic partial cross-sectional view of the pair of eyeglasses of FIG. 1 showing rotation of the earpiece frame thereof in accordance with the present invention.

### DETAILED DESCRIPTION OF PREFERRED EMBODIMENT

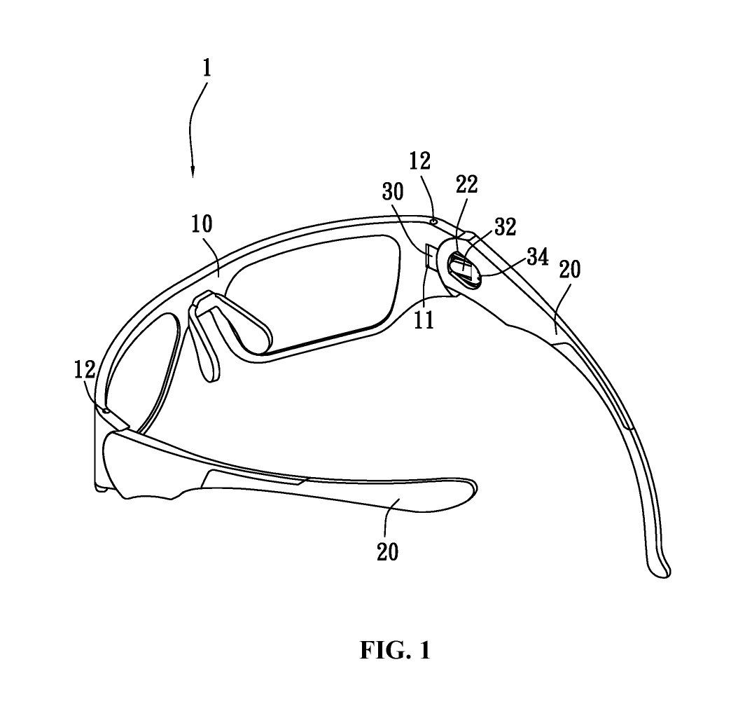

Referring to FIGS. 1 to 6, schematic views of a pair of eyeglasses in accordance with an embodiment of the present invention are shown. A structure of eyeglasses in accordance with the best embodiment of the present invention can be applied to all kinds of eyeglasses 1 so that any applied pair of eyeglasses has functions to replace an earpiece frame 20 thereof and to adjust positions of the earpiece frame 20 thereof.

The structure of eyeglasses in accordance with the present invention comprises a lens chassis 10 and two earpiece frames 20. The two earpiece frames 20 are respectively disposed at two opposite sides of the lens chassis 10 (As shown in FIG. 1). Lenses are installed in the lens chassis 10, and the lenses can be either a corrective one having powers or a plain one without any power. Besides, the lenses can be photochromatic (Such as a photochromatic lens for sunglasses). Furthermore, the two earpiece frames 20 are respectively placed above a left ear and a right ear of a user in order to position the lens chassis 10 in front of eyes of the user for use.

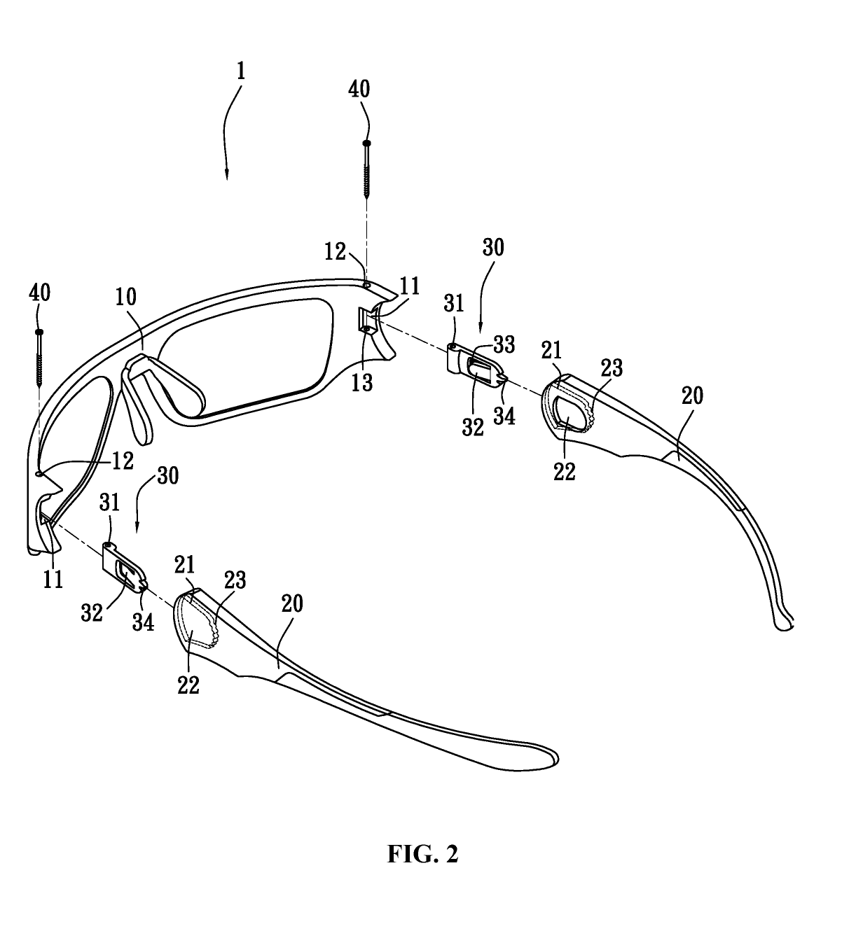

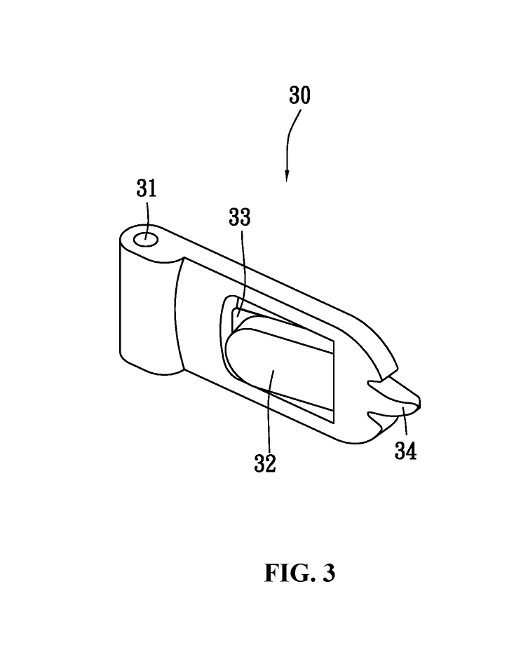

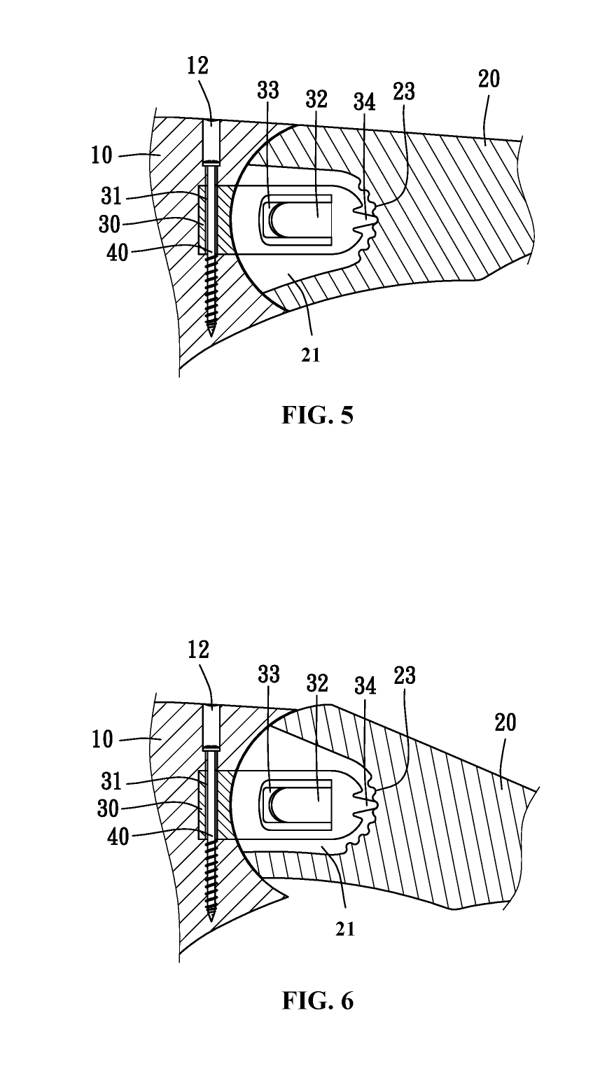

Meanwhile, a connecting part 30 is disposed between each of the two opposite sides of the lens chassis 10 and a corresponding one of the two earpiece frames 20. The connecting part 30 is connected with the each of the two opposite sides of the lens chassis 10 at one end of the connecting part 30 (As shown in FIGS. 2 and 3). A recess 11 is formed at the each of the two opposite sides of the lens chassis 10. The one end of the connecting part 30 is accommodated in the recess 11. A through hole 31 is formed at the one end of the connecting part 30. Furthermore, a passing hole 12 and a screw hole 13 are formed at the recess 11 of the each of the two opposite sides of the lens chassis 10, and the passing hole 12 and the screw hole 13 are correspondingly aligned with each other in the recess 11. The passing hole 12 penetrates through the lens chassis 10 to reach an outer edge of the lens chassis 10. On the contrary, the screw hole 13 is a blind hole without penetrating to reach another outer edge of the lens chassis 10. Accordingly, when the one end of the connecting part 30 is accommodated in the recess 11 of the each of the two opposite sides of the lens chassis 10, a screw 40 is able to penetrate into the passing hole 12 located at the outer edge of the lens chassis 10 (As shown in FIGS. 5 and 6), then to penetrate through the through hole 31 at the one end of the connecting part 30, and finally to be screwed and fixed in the recess 11. Meanwhile, no screw thread is formed at an upper portion of the screw 40 used to be positioned inside the passing hole 12 and the through hole 31. As a result, the one end of the connecting part 30 is facilitated to rotate back and forth along a left-to-right direction in the recess 11.

Besides, a pressing resilient piece 32 is disposed in the connecting part 30. The pressing resilient piece 32 extends inwards from the other end of the connecting part 30 with an angle of elevation of 5° to 20°. As a result, the pressing resilient piece 32 of the connecting part 30 is equipped with resiliency in response to pressing. Furthermore, a sheet flange 33 is formed to extend forward from a front distal end of the pressing resilient piece 32 of the connecting part 30 (an elevation portion of the pressing resilient piece 32). The extending sheet flange 33 is formed for a function of abutting. A pointing tip 34 is formed at an outer edge of the other end of the connecting part 30.

Meanwhile, an accommodating space 21 is formed at one end of the corresponding one of the two earpiece frames 20. An aperture 22 is formed at a lateral side of the one end of the corresponding one of the two earpiece frames 20. An edge of the aperture 22 is curved. Besides, a tooth groove 23 having protruding teeth formed therein is formed in the accommodating space 21, and the tooth groove 23 is curved (As shown in FIG. 2). When the extending pointing tip 34 of the other end of the connecting part 30 penetrates through the accommodating space 21 of the one end of the corresponding one of the two earpiece frames 20, the extending pointing tip 34 of the other end of the connecting part 30 is correspondingly placed in the tooth groove 23 of the accommodating space 21 of the one end of the corresponding one of the two earpiece frames 20 to point at a location in the tooth groove 23 between two of the protruding teeth of the tooth groove 23. The extending pointing tip 34 of the other end of the connecting part 30 correspondingly points at a different location in the tooth groove 23 when the tooth groove 23 of the accommodating space 21 of the one end of the corresponding one of the two earpiece frames 20 rotates to a different position thereof in response to rotation of the corresponding one of the two earpiece frames 20. As a result, the corresponding one of the two earpiece frames 20 is equipped with a function of rotating up and down within a stretching range of the tooth groove 23. Accordingly, the corresponding one of the two earpiece frames 20 is able to adjust positions and angles thereof.

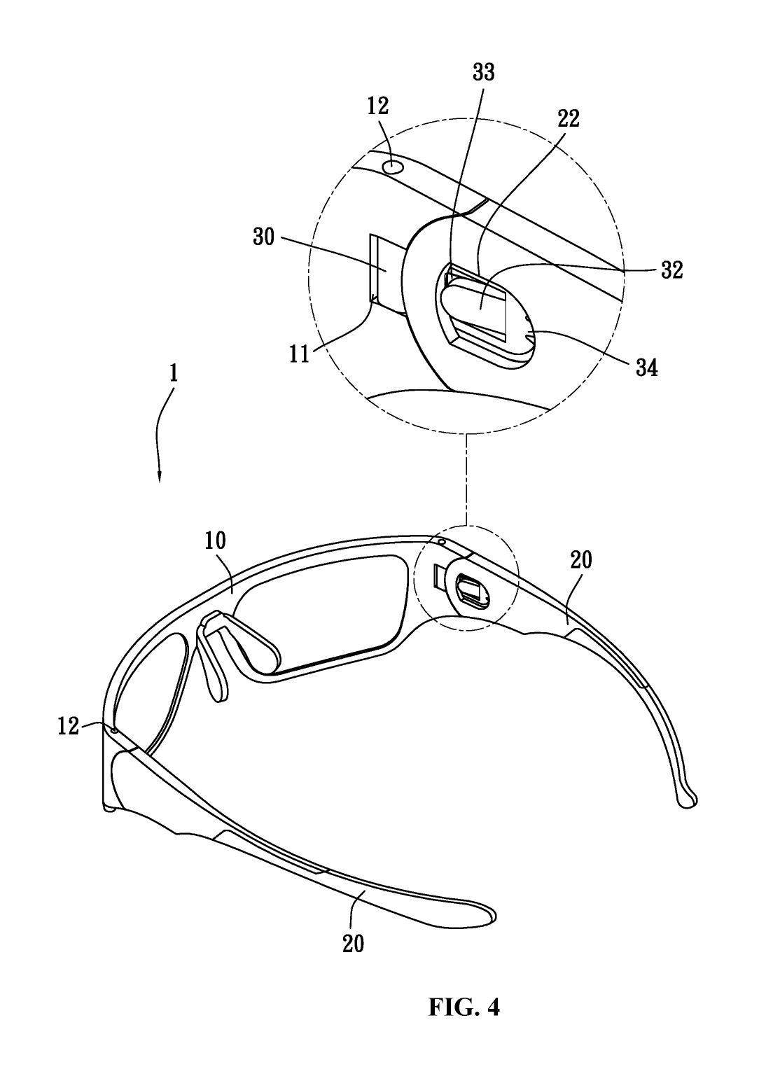

Additionally, when the other end of the connecting part 30 is assembled in the accommodating space 21 of the one end of the corresponding one of the two earpiece frames 20, the pressing resilient piece 32 in the connecting part 30 abuts against the aperture 22 of the lateral side of the one end of the corresponding one of the two earpiece frames 20 (As shown in FIG. 4). The extending sheet flange 33 of the front distal end of the pressing resilient piece 32 of the connecting part 30 (the elevation portion of the pressing resilient piece 32) also abuts against a hole edge of the aperture 22 of the lateral side of the one end of the corresponding one of the two earpiece frames 20. As a result, the pressing resilient piece 32 in the connecting part 30 steadily and fixedly abuts against the aperture 22 of the lateral side of the one end of the corresponding one of the two earpiece frames 20. Hence, the corresponding one of the two earpiece frames 20 will not be detached from the connecting part 30 during rotation of the corresponding one of the two earpiece frames 20, and therefore rotation of the corresponding one of the two earpiece frames 20 is conveniently performed.

Although only the preferred embodiments of the present invention are described as above, the claim scope of the present invention is not limited to the disclosed embodiments. It is understood that any simple equivalent changes, adjustments or modifications to the present invention can be made by ordinary skilled in the art without separating from the inventive spirit and the claimed scope of the present invention. Hence, the protective scope of the present invention should be defined by the claimed scope of the following claims of the present invention.

What is claimed is:

1. A pair of eyeglasses comprising a lens chassis and two earpiece frames, the two earpiece frames respectively disposed at two opposite sides of the lens chassis, wherein a connecting part is disposed between each of the two opposite sides of the lens chassis and a corresponding one of the two earpiece frames, the connecting part is connected with the each of the two opposite sides of the lens chassis at one end of the connecting part, a pressing resilient piece is disposed in the connecting part, an accommodating space is formed at one end of the corresponding one of the two earpiece frames, an aperture is formed at a lateral side of the one end of the corresponding one of the two earpiece frames, when the other end of the connecting part is assembled in the accommodating space of the one end of the corresponding one of the two earpiece frames, the pressing resilient piece in the connecting part abuts against the aperture of the lateral side of the one end of the corresponding one of the two earpiece frames.

2. The pair of eyeglasses as claimed in claim 1, wherein a tooth groove having protruding teeth formed therein is further formed in the accommodating space of the one end of the corresponding one of the two earpiece frames.

3. The pair of eyeglasses as claimed in claim 1, wherein a pointing tip is further formed and extends at the other end of the connecting part.

4. The pair of eyeglasses as claimed in claim 1, wherein a sheet flange is formed to extend from a front distal end of the pressing resilient piece of the connecting part.

5. The pair of eyeglasses as claimed in claim 1, wherein a through hole is formed at the one end of the connecting part.

6. The pair of eyeglasses as claimed in claim 1, wherein a recess is formed at the each of the two opposite sides of the lens chassis to accommodate the one end of the connecting part.

7. The pair of eyeglasses as claimed in claim 6, wherein a passing hole and a screw hole are formed at the recess, and the passing hole penetrates through the lens chassis to reach an outer edge of the lens chassis.
